(19) United States
(12) Patent Application Publication
(10) Pub. No.: US 2023/0386356 A1
(43) Pub. Date: Nov. 30, 2023

(54) INTELLIGENT TUTORING METHOD AND SYSTEM

(71) Applicant: Electronics and Telecommunications Research Institute, Daejeon (KR)

(72) Inventors: Jinxia HUANG, Daejeon (KR); Oh Woog KWON, Daejeon (KR)

(73) Assignee: Electronics and Telecommunications Research Institute, Daejeon (KR)

(21) Appl. No.: 17/960,356

(22) Filed: Oct. 5, 2022

(30) Foreign Application Priority Data
May 26, 2022 (KR) 10-2022-0064813

(51) Int. Cl. G09B 7/04

(52) U.S. Cl. CPC G09B 7/04

(57) ABSTRACT

An intelligent tutoring method of an intelligent tutoring system is provided. The intelligent tutoring method includes: receiving learning material; selecting an utterance type in a current dialogue turn; selecting grounded knowledge from the learning material according to the selected utterance type in the current dialogue turn; generating a tutor utterance based on the selected utterance type, the grounded knowledge, and the learning material in the current dialogue turn and outputting it to the learner; receiving a learner utterance in response to the tutor utterance in the current dialogue turn; and generating an assessment result of the learner utterance by assessing the learner utterance in the current c dialogue turn.

### CROSS-REFERENCE TO RELATED APPLICATION

This application claims priority to and the benefit of Korean Patent Application No. 10-2022-0064813 filed in the Korean Intellectual Property Office on May 26, 2022, the entire contents of which are incorporated herein by reference.

### BACKGROUND OF THE INVENTION

### (a) Field of the Invention

The present disclosure relates to an intelligent tutoring method and system, and more particularly, to an intelligent tutoring method and system for assessing a learner utterance and generating a system utterance based on given learning materials.

### (b) Description of the Related Art

Background technology of the dialogue-based tutoring system includes a task-oriented dialogue technology, a knowledge-grounded dialogue technology, and a dialogue-based intelligent tutoring technology.

The task-oriented dialogue technology analyzes user intention, tracks the dialogue state, determines a dialogue act according to dialogue policy, and generates a system response. With the development of deep learning technology, a study on an end-to-end task-oriented dialogue technology that outputs user intention, dialogue act, and system response as one dialogue model is in progress.

There are many difficulties in realizing a dialogue-based tutoring system with the conventional task-oriented dialogue technology. Unlike task-oriented dialogue that completes a task in one or several domains, such as hotel reservations or taxi reservations, a dialogue for tutoring may have hundreds or more dialogue topics or fields. In particular, in order to construct training data necessary for user intention analysis and dialogue act prediction, an expert defines slot names required for each dialogue topic or field, and tags information such as slots and dialogue acts for dialogue data. Thus, as the dialogue domain and tasks are varied, the difficulty of constructing training data increases, and the prediction performance of the system reduced.

Knowledge-grounded dialogue technology is a deep learning-based dialogue technology that generates informative dialogue using knowledge such as given texts. The system selects the necessary knowledge according to the user utterance, and generates a system response based on this knowledge.

In order to realize a dialogue-based tutoring system with the conventional knowledge-based dialogue technology, there is an assessment problem on the learner utterance, and when there is an error, the system should be able to induce the learner to utter a correct answer by providing a hint such as a recommended correct answer (reference) or grounded knowledge through system utterance. However, in the knowledge-based dialogue technology, it does not discriminate whether there is an error in the learner utterance, and it is difficult to generate utterances suitable for the learning purpose, since the knowledge selected according to the existing dialogue context is also irrelevant whether the learner utterance is correct or not.

The dialogue-based intelligent tutoring technology helps learners acquire knowledge through dialogue, conducts the dialogue according to a given dialogue scenario, assesses the learner response, and provides feedback including hints so that the learner can try again when the learner fails to respond correctly. The conventional intelligent tutoring technology is composed of several modules, and uses element technologies such as analysis and assessment for each module. In addition, in the conventional dialogue-based intelligent tutoring system, a dialogue can be conducted according to a dialogue scenario only when the dialogue scenario is constructed in accordance with all learning materials. That is, the conventional dialogue-based intelligent tutoring system proceeds based on a scenario, and since all possible learner responses must be added to the scenario, it needs to construct many scenarios to learn one piece of text, and it requires the input of professional manpower who understand both the dialogue system and the tutoring system well.

On the other hand, there is no study or service on an end-to-end dialogue-based intelligent tutoring system using deep learning technology yet.

### SUMMARY OF THE INVENTION

The present disclosure has been made in an effort to provide an intelligent tutoring method and system capable of providing tutoring to learners without constructing many scenarios.

In addition, the present disclosure is to provide an intelligent tutoring method and system that can provide tutoring to learners based on an end-to-end dialogue using deep learning technology.

According to an embodiment, an intelligent tutoring method of an intelligent tutoring system is provided. The intelligent tutoring method includes: receiving learning material; selecting an utterance type in a current dialogue turn; selecting grounded knowledge from the learning material according to the selected utterance type in the current dialogue turn; generating a tutor utterance based on the selected utterance type, the grounded knowledge, and the learning material in the current dialogue turn and outputting it to the learner; receiving a learner utterance in response to the tutor utterance in the current dialogue turn; and generating an assessment result of the learner utterance by assessing the learner utterance in the current c dialogue turn.

The selecting the grounded knowledge may include: selecting key sentences from the learning material with reference to the selected utterance type; and selecting the key sentences as the grounded knowledge.

The selecting the key sentences may include selecting the key sentences from the learning material based on the selected utterance type and the assessment result of the learner utterance in a previous dialogue turn.

The selecting the key sentences as the grounded knowledge may include classifying whether the grounded knowledge is the grounded knowledge to be referenced for the tutor utterance or the grounded knowledge to be referenced for the assessment of the learner utterance.

The selecting grounded knowledge may further include selecting a question point in the key sentences.

The utterance type may include at least a Question type and a Feedback type, and the selecting the utterance type may include selecting the utterance type of the current dialogue turn as the Feedback type when the assessment result of the learner utterance in the previous dialogue turn indicates an incorrect answer; and using a question index of the previous dialogue turn as the question index of the current dialogue turn.

The selecting the ground knowledge may include selecting the ground knowledge selected in the previous dialogue turn as the ground knowledge in the current dialogue turn when the utterance type in the current dialogue turn is the Feedback type.

According to another embodiment, an intelligent tutoring method of an intelligent tutoring system is provided. The intelligent tutoring method includes: receiving learning material, utterance types up to a current dialogue turn, and ground knowledges selected from the learning material as inputs, and generating a tutor utterance in the current dialogue turn and outputting it to the learner, in one learned end-to-end dialogue model; and receiving, as inputs, the tutor utterance in the current dialogue turn and the learner utterance corresponding to the tutor utterance, and assessing the learner utterance, in the one end-to-end dialogue model.

The intelligent tutoring method may further include: receiving the learning material; selecting an utterance type in the current dialogue turn; selecting the ground knowledge from the learning material according to the utterance type selected in the current dialogue turn; and inputting the learning material, the utterance type in the current dialogue turn, and the ground knowledge into the one end-to-end dialogue model.

The selecting the utterance type in the current dialogue turn may include selecting the utterance type in the current dialogue turn based on the assessment result of the learner utterance assessed by the one end-to-end dialogue model in the previous dialogue turn and the learning material.

The selecting the utterance type may include, in the one end-to-end dialogue model, receiving the learning material and the assessment result of the learner utterance assessed by the one end-to-end dialogue model in the previous dialogue turn as inputs, and determining the utterance type in the current dialogue turn.

The generating the tutor utterance in the current dialogue turn and outputting it to the learner may include inputting the assessment result of the learner utterance assessed by the one end-to-end dialogue model into the one end-to-end dialogue model for generating a tutor utterance in the next dialogue turn.

The generating the tutor utterance in the current dialogue turn and outputting it to the learner may include selecting the ground knowledge by using the learning material and the utterance types up to the current dialogue turn in the one end-to-end dialogue model.

The intelligent tutoring method may further include training the end-to-end dialogue model using training data, and the training may include generating the training data from the learning material.

According to yet another embodiment, an intelligent tutoring system is provided. The intelligent tutoring system includes: an utterance type selector that selects an utterance type based on input learning material; a grounded knowledge selector that selects grounded knowledge from the learning material based on the selected utterance type; a tutor utterance generator that generates, based on the learning material, the selected utterance type and grounded knowledge and outputs a tutor utterance to a learner, and a learner utterance assessor that receives a learner utterance corresponding to the tutor utterance, and generates an assessment result of the learner utterance by assessing the learner utterance based on at least one of the learning material, the utterance type, the grounded content, and the tutor utterance.

The grounded knowledge selector may classify the grounded knowledge selected from the learning material into the grounded knowledge required for the tutor utterance and the grounded knowledge required for the assessment of the learner utterance.

The grounded knowledge selector may select key sentences from the learning material according to the utterance type, and may output the key sentences as the grounded knowledge.

The tutor utterance generator may generate the tutor utterance based on the learning material, the assessment result of the learner utterance and the learner utterance in the previous dialogue turn, and the utterance type and grounded knowledge in the current dialogue turn.

The tutor utterance generator and the learner utterance assessor may generate the tutor utterance using one learned end-to-end dialogue model and may assess the learner utterance.

The utterance type selector may select the utterance type using the one end-to-end dialogue model, or the grounded knowledge selector may select the grounded knowledge by using the one end-to-end dialogue model.

### BRIEF DESCRIPTION OF THE DRAWINGS

FIG. 1 is a diagram illustrating an intelligent tutoring system according to an embodiment.

FIG. 2 is a flowchart illustrating an intelligent tutoring method of the intelligent tutoring system shown in FIG. 1.

FIG. 3 to FIG. 5 are diagrams showing an example of learning materials, respectively.

FIG. 6 is a flowchart illustrating an example of a method for selecting an utterance type in an utterance type selector shown in FIG. 1.

FIG. 7 is a flowchart illustrating an example of a method for selecting grounded knowledge of the grounded knowledge selector shown in FIG. 1.

FIG. 8 is a flowchart illustrating an example of a method for generating tutor utterances in a tutor utterance generator shown in FIG. 1.

FIG. 9 is a diagram illustrating an example of a method of generating a tutor utterance in a first dialogue turn of the tutor utterance generator shown in FIG. 1.

FIG. 10 is a flowchart illustrating an example of a method for assessing learner utterance in a learner utterance assessor shown in FIG. 1.

FIG. 11 is a diagram illustrating an intelligent tutoring system according to another embodiment.

FIG. 12 is a diagram illustrating an example of dialogue data for tutoring constructed according to the example of history tutoring shown in FIG. 3.

FIG. 13 is a diagram illustrating an example of dialogue data for tutoring constructed according to the example of job training for service center staff shown in FIG. 4.

FIG. 14 is a diagram showing an example of various dialogues for tutoring constructed based on the learning materials in English tutoring shown in FIG. 5.

FIG. 15 is a diagram illustrating an example of an intelligent tutoring dialogue using the learning material shown in FIG. 5 of the intelligent tutoring system according to an embodiment.

FIG. 16 is a diagram illustrating another example of an intelligent tutoring dialogue using the learning material shown in FIG. 5 of the intelligent tutoring system according to an embodiment.

FIG. 17 is a diagram illustrating an example of an intelligent tutoring dialogue using the learning material shown in FIG. 3 of the intelligent tutoring system according to an embodiment.

FIG. 18 is a diagram illustrating an example of an intelligent tutoring dialogue using the learning material shown in FIG. 4 of an intelligent tutoring system according to an embodiment.

FIG. 19 is a diagram illustrating an intelligent tutoring system according to another embodiment.

### DETAILED DESCRIPTION OF THE EMBODIMENTS

Hereinafter, embodiments of the disclosure will be described in detail with reference to the attached drawings so that a person of ordinary skill in the art may easily implement the disclosure. As those skilled in the art would realize, the described embodiments may be modified in various different ways, all without departing from the spirit or scope of the disclosure. The drawings and description are to be regarded as illustrative in nature and not restrictive. Like reference numerals designate like elements throughout the specification.

Throughout the specification and claims, when a part is referred to “include” a certain element, it means that it may further include other elements rather than exclude other elements, unless specifically indicated otherwise.

Furthermore, in this specification, each of the phrases such as “A or B”, “at least one of A and B”, “at least one of A or B”, “A, B, or C”, “at least one of A, B, and C”, and “at least one of A, B, or C” may include any one of the items listed together in the corresponding one of the phrases, or all possible combinations thereof.

Now, an intelligent tutoring method and system according to an embodiment of the present disclosure will be described in detail with reference to the drawings.

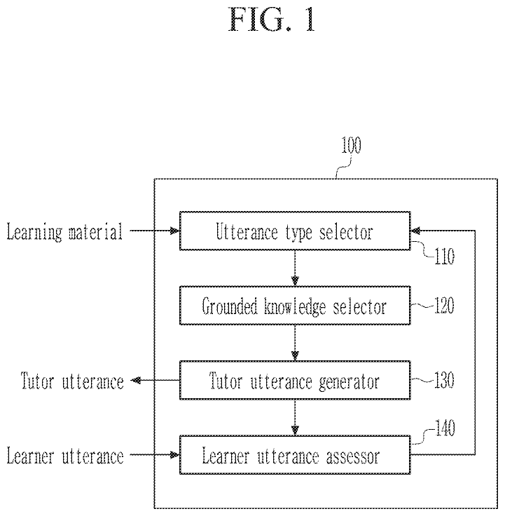

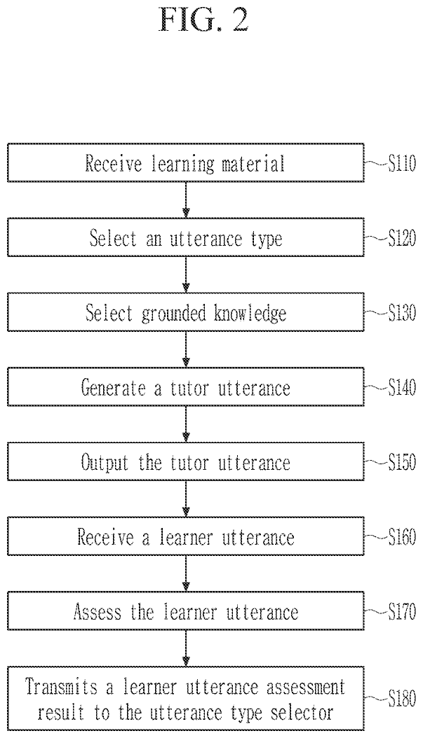

FIG. 1 is a diagram illustrating an intelligent tutoring system according to an embodiment, and FIG. 2 is a flowchart illustrating an intelligent tutoring method of the intelligent tutoring system shown in FIG. 1.

Referring to FIG. 1, the intelligent tutoring system 100 includes an utterance type selector 110, grounded knowledge selector 120, a tutor utterance generator 130, and a learner utterance assessor 140.

Referring to FIG. 1 and FIG. 2, the utterance type selector 110 receives learning material from the outside (S110), and automatically selects an utterance type of the tutor utterance (S120). The learning material may include a description of knowledge or a scenario including dialogue. The selection of the utterance type is a step in which the tutor selects which type of utterance to use.

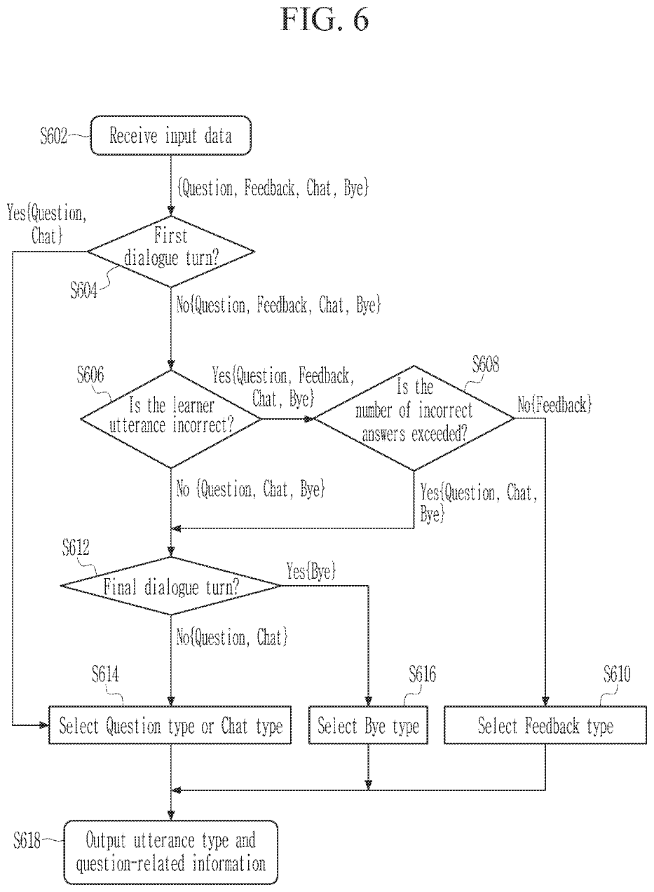

The most basic utterance types may include a Question type and a Feedback type that provides hints. The Question type is to check whether the learner has properly understood the learning material, and it is a case of uttering a question about the learning material. The Feedback type is a case of providing a hint so that the learner can infer the correct answer when the assessment result of the learner utterance is an error. In addition, a topic-based Chat type that shares personal views or experiences related to a given learning material, or a Bye type, which means ending the dialogue, may be additionally used as the utterance types. The utterance type selector 110 may select the utterance type based on the method described with reference to FIG. 6 to be described later.

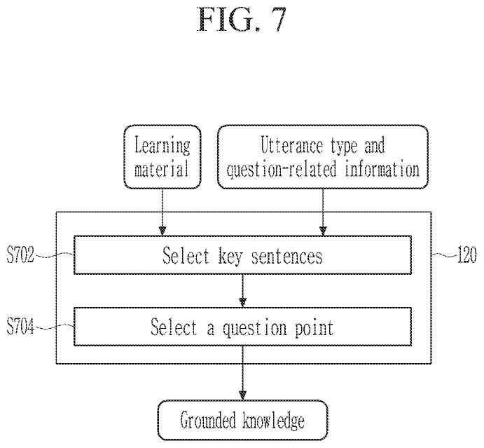

The grounded knowledge selector 120 automatically selects grounded knowledge from the learning material according to the selected utterance type (S130). The grounded knowledge selector 120 may classify the grounded knowledge required for assessment of the tutor utterance and the learner utterance when selecting the grounded knowledge from the learning material according to the selected utterance type. At this time, although the ground knowledge required for assessment of the tutor utterance and the learner utterance is classified, both the ground knowledge required for assessment of the tutor utterance and the learner utterance can be referred to when the tutor utters, or assessing learner utterance. The ground knowledge selector 120 may select the ground knowledge based on the method described with reference to FIG. 7 to be described later. The grounded knowledge selector 120 may output the grounded knowledge to the learner if necessary.

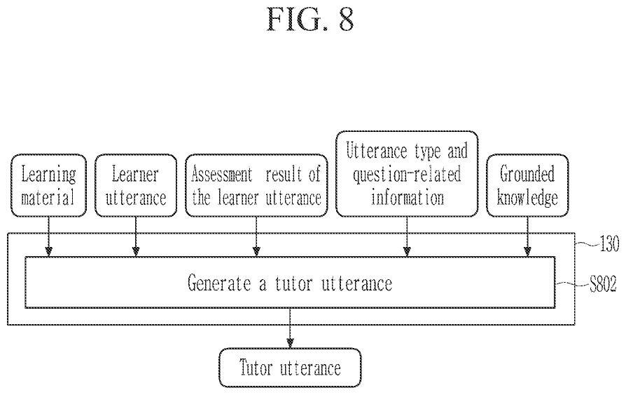

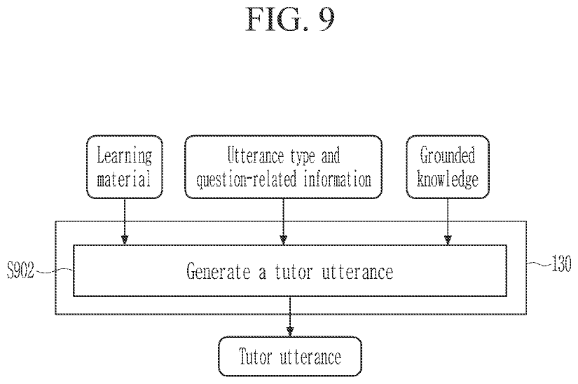

The tutor utterance generator 130 generates a tutor utterance in consideration of the selected ground knowledge (S140), and outputs the tutor utterance to the learner (S150). The tutor utterance generator 130 may generate the tutor utterance based on the method described with reference to FIGS. 8 and 9 to be described later.

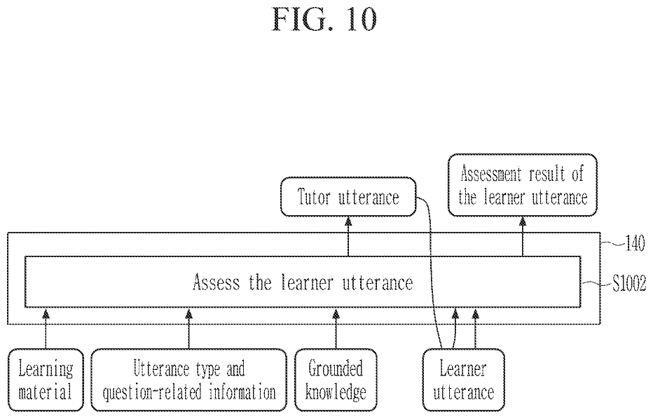

The learner utterance assessor 140 receives a learner utterance with respect to the output tutor utterance (S160), and assesses the learner utterance (S170). The learner utterance assessment result of the learner utterance assessor 140 is transmitted to the utterance type selector 110 (S180). The learner utterance assessor 140 may assess the learner utterance based on the method described with reference to FIG. 10 to be described later, and may output the learner utterance assessment result to the utterance type selector 110. The learner utterance assessor 140 may output the learner utterance assessment result to the learner if necessary.

When the utterance type selector 110 receives the learner utterance assessment result of the previous dialogue turn, and automatically selects the utterance type of the next dialogue turn according to the learner utterance assessment result of the previous dialogue turn (S120). Thereafter, the intelligent tutoring system 100 performs steps S130 to S180, and provides a dialogue-based tutoring service while repeating steps S120 to S180 until the Bye type is selected by the utterance type selector and the tutor utterance corresponding to the ending greeting is output. The dialogue of the repeated steps may be performed by referring to a dialogue history including all received and output information up to the previous steps or a part thereof. For example, for the generation of tutor utterances of the second dialogue turn in the step S140, all or part of the information from the utterance type to the learner utterance and assessment of the first dialogue turn, the learning material in the step S110 of the second dialogue turn, utterance type in the step S120 of the second dialogue turn, and grounded knowledge in the step S130 of the second dialogue turn, can be referred to.

In the intelligent tutoring system 100 according to the embodiment, “dialogue” represents an interaction for exchanging information between a system acting as a tutor and a user corresponding to a learner, and may include inputs such as learning materials or learner utterances and outputs such as tutor utterances. Such input and output can be in various formats such as text, voice, picture, and video. Below, input and output of the text format are used as an example for convenience of explanation.

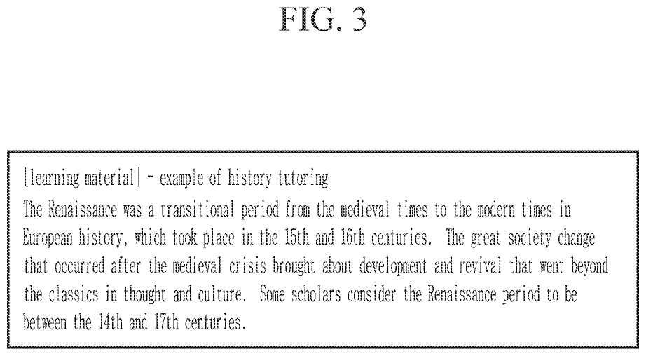

FIG. 3 to FIG. 5 are diagrams showing an example of learning materials, respectively.

As shown in FIGS. 3 to 5, the learning materials may include contents in various fields such as history tutoring, job training for service center staff, and English language tutoring.

The learning materials may be provided in various formats such as text, voice, picture, and video, and FIGS. 3 to 5 show the learning material of text format.

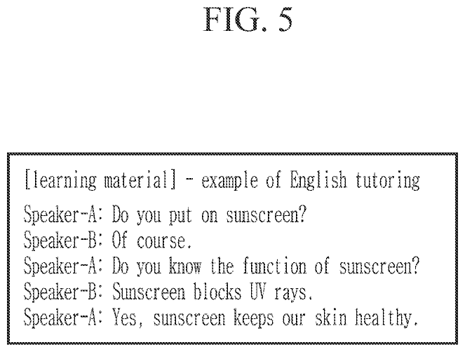

In addition to the examples shown in FIGS. 3 to 5, the learning material may include major learning points in the corresponding learning material. The major learning points may include vocabulary and grammar information to be learned along with subject content in language tutoring. For example, in the example of “English tutoring” in FIG. 5, “sunscreen” and “keep˜healthy” may be included in the learning material. The major learning points may also include exercises that are commonly used to achieve tutoring goals. For example, the exercise “Question: When did the Renaissance take place? Answer: 15th and 16th centuries”, related to the “example of historical tutoring” of FIG. 3, etc. may be included in the learning material.

FIG. 6 is a flowchart illustrating an example of a method for selecting an utterance type in an utterance type selector shown in FIG. 1.

Referring to FIG. 6, the utterance type may include a Question type, a Feedback type, and a Chat type, and if necessary, a Bye type indicating an end greeting may be added. The number of Question type utterances (questions, in the following) per learning material, the maximum number of Feedback type utterances allowed for question, and the ratio of Question type to Chat type are predetermined for each learning material, or may be automatically determined by the system automatically according to the difficulty and length of the learning material. The maximum number of Feedback type utterances allowed for each question may be equal to the number of learner incorrect answers allowed for each question. The utterance type that must exist in the tutoring system is the Question type, and other utterance types can be added as needed.

When the utterance type selector 110 receives input data (S602), it selects the utterance type. Specifically, the utterance type selector 110 checks whether it is the first dialogue turn (S604). The input data may include at least one of learning materials, an existing dialogue context, and an assessment result of a learner utterance. For example, in the case of the first dialogue turn, the existing dialogue context and the assessment result data of the learner utterance are not included in the input data. In this case, an appropriate expression indicating that there are no data such as “none” in the items for the existing dialogue context and the assessment result data of the learner utterance may be used.

When it is the first dialogue turn (S604), the utterance type selector 110 selects Question type or Chat type among the utterance types (S614). The method of selecting one of the Question type or the Chat type may be randomly selected according to the utterance ratio of the predefined Question type and the Chat type, or may be automatically selected through a generative model according to the distribution in the training corpus.

When it is not the first dialogue turn (S604), the utterance type selector 110 checks whether the learner utterance is an incorrect answer from the assessment result of the learner utterance among the input data (S606).

When the learner utterance is an incorrect answer, the utterance type selector 110 checks whether the number of incorrect answers of the learner utterance exceeds a predetermined number of times (S608). When the number of incorrect answers of the learner utterance does not exceed the predetermined number of times, the utterance type selector 110 selects Feedback type as the utterance type (S610).

On the other hand, the utterance type selector 110 checks whether the current dialogue turn is the final dialogue turn when the number of incorrect answers of the learner utterance exceeds the predetermined number of times (S608). When it is not the final dialogue turn, the utterance type selector 110 selects Question type or Chat type as the utterance type (S614), and when it corresponds to the final dialogue turn, Bye type is selected as the utterance type (S616).

As such, the utterance type selected in the next dialogue turn is determined according to whether the number of incorrect answers of the learner utterance in the current dialogue turn exceeds the predetermined number of times. For example, it is possible to output an incorrect answer once for the same question, and if the learner utters an incorrect answer again after the tutor utterance according to the Feedback type, the tutoring system immediately outputs the correct answer, and may proceed to the next dialogue turn (next Question type, Chat type, or Bye type).

The utterance type selector 110 may select the utterance type in the current dialogue turn in this way, and may output question-related information together with the selected utterance type of the current dialogue turn (S618). The question-related information has an utterance type identifier for identification of the corresponding utterance type and a question index (qa-idx) to be proceeded next as essential information. The question-related information may additionally include the total number of questions (question number: qa-num) that the tutor must utter in order to end the dialogue additionally and the total number of incorrect answers to the current if necessary, and may also include the number of incorrect answers of the learner utterance in the corresponding question index when the utterance type is Feedback. The total number of incorrect answers to the current can be used when generating a general review of learner utterance for the corresponding learning material in the final dialogue turn.

Meanwhile, the utterance type selector 110 may use the number of questions and the ratio of Question type to Chat type to determine whether it is the final dialogue turn in step S612. For example, the utterance type selector 110 may determine to end the dialog, when the number of questions determined for each learning material was asked in the tutor utterances, and the ratio of Question type to Chat type was matched when the Chat type is allowed.

In addition, the utterance type shown in FIG. 6 is an example, and instead of the Feedback type, a Reference type that immediately informs the correct answer and goes over may be used, or a Feedback type and a Reference type may be used together. When the utterance type defined in the intelligent tutoring system 100 shown in FIG. 1 is changed, the utterance type selection process shown in FIG. 6 may also vary according to the defined utterance type.

FIG. 7 is a flowchart illustrating an example of a method for selecting grounded knowledge of the grounded knowledge selector shown in FIG. 1.

Referring to FIG. 7, the grounded knowledge selector 120 selects the grounded knowledge required for the tutor utterance from the learning materials according to the utterance type selected by the utterance type selector 110.

Specifically, the grounded knowledge selector 120 selects key sentences from the learning materials based on the learning materials, the utterance type selected by the utterance type selector 110, and question-related information (S702).

Next, the grounded knowledge selector 120 selects a question point, such as an entity name, from one or more selected key sentences (S704), and outputs the question point together with the key sentences to the tutor utterance generator 130 as the grounded knowledge. The grounded knowledge selector 120 may also determine a 5W1H (When, Where, Who, What, Why, How) question type for the selected question point and output it together as the grounded knowledge.

The grounded knowledge selector 120 may use methods and results such as keyword extraction, morpheme analysis, entity name recognition, syntax analysis, and keyword-based search for key sentences selection and question point selection.

The grounded knowledge selector 120 may apply a search-based method such as term frequency-inverse document frequency (TF-IDF) or BM25, and may use a deep learning model-based search technique to select the key sentences most relevant to a given dialogue context.

Meanwhile, when the utterance type is a Chat type, the grounded knowledge selector 120 may use the entire learning material as the grounded knowledge.

The grounded knowledge selector 120 may select a specific entity name recognition as the question point using the entity name recognition method, but may also output the 5W1H question type (e.g., why, when) for the selected key sentences by using deep learning-based generation. Also, the grounded knowledge selector 120 may utilize information such as the utterance type, the question index (qa-idx), and the total number of questions (qa-num).

When a major learning point is included in the learning material, the grounded knowledge selector 120 may select a question point with reference to the corresponding information. In this embodiment, specific methods of selecting key sentences and selecting question points are not specified.

In addition, the grounded knowledge selector 120 may select only key sentences without a process of selecting a question point and output them directly as the grounded knowledge, and the method of selecting the grounded knowledge is not limited to the method illustrated in FIG. 7.

FIG. 8 is a flowchart illustrating an example of a method for generating tutor utterances in a tutor utterance generator shown in FIG. 1.

Referring to FIG. 8, the tutor utterance generator 130 receives the learning material, the learner utterance in the previous dialogue context, the learner utterance assessment result, the utterance type and question-related information in the current dialogue turn, and the grounded knowledge as inputs, and generates the tutor utterance based on the received inputs (S802). In this case, all inputs may be received as a sequence and embedded as a word vector, but the method is not specified in this embodiment.

The tutor utterance generator 130 outputs the generated tutor utterance to the learner.

The inputs shown in FIG. 8 are an example, and in addition to the learner utterance and the assessment result of the learner utterance in a previous dialogue turn, all existing dialogue history may also be included in the inputs.

FIG. 9 is a diagram illustrating an example of a method of generating a tutor utterance in a first dialogue turn of the tutor utterance generator shown in FIG. 1.

Referring to FIG. 9, in the case of the first dialogue turn, the tutor utterance generator 130 receives learning material, utterance type and question-related information, and grounded knowledge as inputs, and generates a tutor utterance based on the inputs (S902). That is, compared with FIG. 8, in the case of the first dialogue turn, there are no data corresponding to the learner utterance and the assessment result of the learner utterance of the previous dialogue context.

The tutor utterance generator 130 outputs the generated tutor utterance to the learner.

In FIGS. 8 and 9, the tutor utterance generator 130 may generate the tutor utterance using a traditional template-based dialogue generation method. That is, the tutor utterance generator 130 may define various tutor utterances as templates in advance, search and select tutor utterance templates according to all input information, and then generate the tutor utterances based on the template.

Alternatively, the tutor utterance generator 130 may generate the tutor utterances using a typical deep learning-based open domain dialogue model. In FIGS. 8 and 9, the entire input is input and encoded as one sequence, the entire input may be used as a single delimiter (e.g., <sep>), or a delimiter specified for each piece of input data may be used.

As another method of generating tutor utterances, the tutor utterance generator 130 independently encodes all dialogue contexts including grounded knowledge and recent learner utterances using two encoders, like some text-grounded dialogue model implementation. Then, the tutor utterance generator 130 may generate the tutor utterance by allocating weights to the most important dialogue context and grounded knowledge through attention.

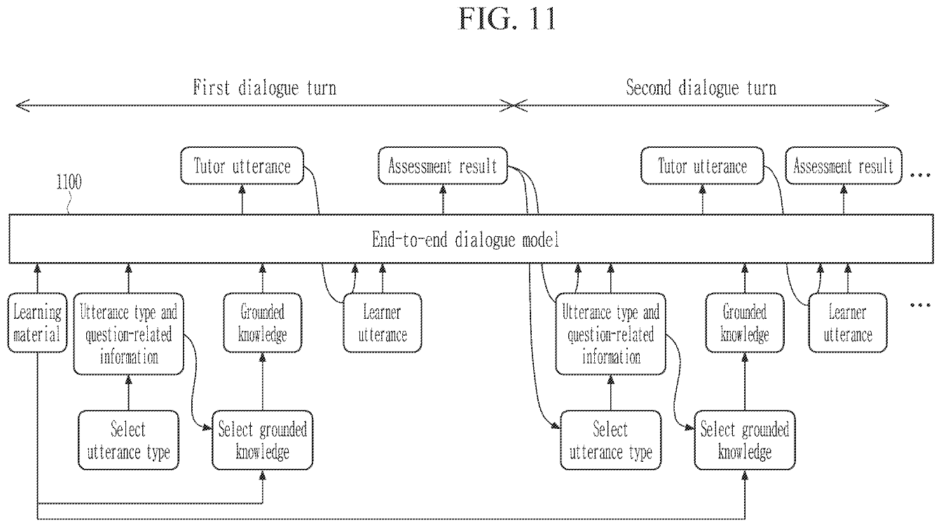

In addition, the tutor utterance generator 130 may generate tutor utterances using a deep learning-based pipeline dialogue generation method using a prior learning language model or a prior learning dialogue model, for example, may use an end-to-end dialogue model. This will be described in detail with reference to FIG. 11.

As such, there are various methods for generating tutor utterances using information input in the intelligent tutoring system 100, and the method for generating tutor utterances is not limited to any one method.

FIG. 10 is a flowchart illustrating an example of a method for assessing learner utterance in a learner utterance assessor shown in FIG. 1.

Referring to FIG. 10, the learner utterance assessor 140 receives learning material, utterance type and question-related information, grounded knowledge, tutor utterance, and learner utterance as inputs for assessment of the learner utterance, and performs an assessment of the most recently input learner utterance (S1002).

The learner utterance assessor 140 outputs the assessment result for the learner utterance to the utterance type selector 110. Although it is illustrated in FIG. 10 that only the recent tutor utterance and the learner utterance are considered, in actual use, all existing dialogue history may also be used as inputs.

The learner utterance assessor 140 may classify the assessment result of the learner utterance only as “fail/success”, or may express the assessment result of the learner utterance as a grade of several steps or a score of a real number. If the Chat type is also allowed in the utterance type, the category of 99) “not assessment target (None)” may be allowed in the assessment result for the learner utterance.

The learner utterance assessor 140 may use a discriminative model to classify “fail/success” or grades when assessing the learner utterance, but may use various methods, such as using a regression model for score assessment. The learner utterance assessor 140 may also use a method of encoding all the inputs of FIG. 10 and then generating an assessment result for the learner utterance in a decoder. In this embodiment, a specific method for assessing learner utterance is not limited.

FIG. 11 is a diagram illustrating an intelligent tutoring system according to another embodiment.

Referring to FIG. 11, the intelligent tutoring system may perform a learner utterance assessment function and a tutor utterance generation function through one learned end-to-end dialogue model 1100.

The end-to-end dialogue model 1100 is trained by a method of fine tuning a pre-trained language model or a pre-trained dialogue model as an tutoring dialogue corpus. The specific neural network structure of the end-to-end dialogue model 1100 is not specific, and in actual application, a transformer structure that is an encoder-decoder structure may be used, or a transformer decoder structure such as a GPT2 structure may be used. A generative model or a search model may be used to output the tutor utterances and the assessment results of the learner utterances, or the assessment result may be trained as a classification task and the tutor utterance may be trained as a generative task using a multi-task learning technique.

An intelligent tutoring method of an intelligent tutoring system based on such end-to-end dialogue model 1100 will be described in detail.

At the first dialogue turn, the learning material, the utterance type and question-related information selected by the utterance type selector 110, and the grounded knowledge selected by the grounded knowledge selector 120 are input to the end-to-end dialogue model 1100.

The end-to-end dialogue model 1100 generates tutor utterance based on inputs, outputs the tutor utterance to the learner, and the tutor utterance is again input to the end-to-end dialogue model 1100. In addition, the learner utterance is input to the end-to-end dialogue model 1100 in response to the tutor utterance.

The end-to-end dialogue model 1100 assesses the learner utterance based on the learning material, the utterance type and question-related information, the grounded knowledge, and the tutor utterance, and outputs the assessment result of the learner utterance.

The assessment result output from the end-to-end dialogue model 1100 in the first dialogue turn is used as an input to the end-to-end dialogue model 1100 for generating tutor utterance and assessment result in the next dialogue turn. In addition, the assessment result output from the end-to-end dialogue model 1100 may be used to select an utterance type in the next dialogue turn.

In the second dialogue turn, the end-to-end dialogue model 1100 receives the utterance type and question-related information selected by the utterance type selector 110, the grounded knowledge selected by the grounded knowledge selector 120, and the assessment result of the learner utterance in a previous dialogue turn as inputs, and generates a tutor utterance based on inputs, outputs the tutor utterance to the learner, and the tutor utterance is again input to the end-to-end dialogue model 1100. The end-to-end dialogue model 1100 may generate the tutor utterance additionally using at least a portion of the inputs used in the previous dialogue turn to generate the tutor utterance and output the tutor utterance to the learner. The tutor utterance is again input to the end-to-end dialogue model 1100. In addition, the learner utterance is input to the end-to-end dialogue model 1100 in response to the tutor utterance.

The end-to-end dialogue model 1100 assesses the learner utterance based on the learning material, the utterance type and question-related information, the grounded knowledge, and the tutor utterance, and outputs the assessment result of the learner utterance. The tutor utterance and assessment result output from the end-to-end dialogue model 1100 in the second dialogue turn are used as input data of the end-to-end dialogue model 1100 to generate tutor utterance and assessment results in the next dialogue turn.

In this way, the end-to-end dialogue model 1100 generates and outputs the tutor utterance until the last dialogue turn, assesses the learner utterance, and outputs the assessment result.

As such, the intelligent tutoring system based on the end-to-end dialogue model 1100 can provide a tutoring service in the form of a dialogue, such as those taught by visiting tutors, without constructing many scenarios as in the prior art.

Meanwhile, although it has been described in FIG. 11 that the end-to-end dialogue model 1100 performs only the functions of generating tutor utterances and assessing learner utterances, the embodiment is not limited thereto. For example, in the end-to-end dialogue 1100, the functions of selecting the utterance type and selecting the grounded knowledge may also be performed. In this case, utterance type information and grounded knowledge are also output from the end-to-end dialogue model 1100, and the output of the end-to-end dialogue model 1100 is used as an input of the end-to-end dialogue model 1100 for the next dialogue turn.

In addition, in FIG. 11, the end-to-end dialogue model 1100 outputs the assessment result of the learner utterance, but in actual use, the learner utterance is not assessed immediately after the learner speech is input, but when the grounded knowledge is input in the immediately next dialogue turn, the end-to-end dialogue model 1100 may assess the learner utterance, and include the assessment result of the learner utterance in the tutor utterance of the next dialogue turn and output it. In addition, the embodiment is not limited to the order shown in FIG. 11 and can be applied in various ways.

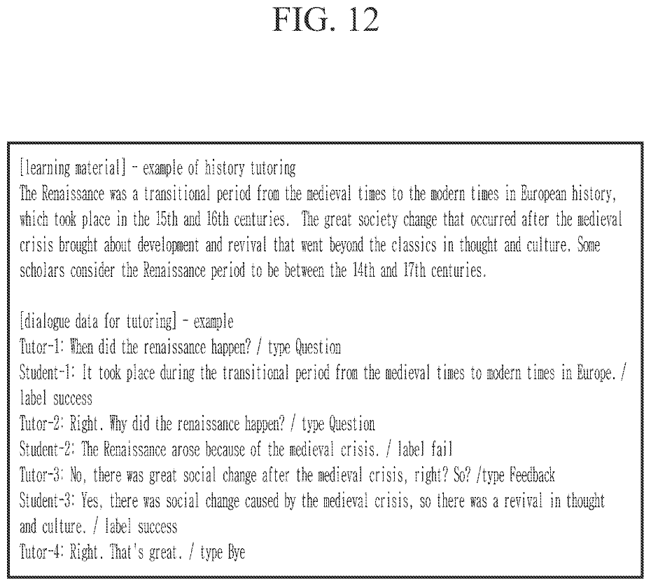

On the other hand, in order to train the end-to-end dialogue model 1100, as in the example of FIG. 12, dialogue data for tutoring may be required together with the learning materials. Although the dialogue data for tutoring of FIG. 12 is essential for training of the end-to-end dialogue model 1100, in order to conduct an intelligent tutoring dialogue using the already trained end-to-end dialogue model 1100, only the learning material in FIG. 12 are required.

The dialogues for tutoring are dialogues constructed on the basis of learning material, and are usually in the form of questions asked by the tutor and answers by the learner. However, in language tutoring, the dialogues for tutoring are possible for the learner to speak first for the practice of the learner. In order to train the end-to-end dialogue model 1100, incorrect answers may be included in the learner utterances in addition to the correct answers, and tutor feedback based on the assessment results may be included in the tutor utterances of the next dialogue turn.

The dialogue data for tutoring can be constructed by humans, but can also be automatically generated from learning materials. In this embodiment, a method of constructing or generating a dialogue corpus for tutoring is not specified.

FIG. 12 is a diagram illustrating an example of dialogue data for tutoring constructed according to the example of history tutoring shown in FIG. 3.

Referring to FIG. 12, the utterance type (Question type, Chat type, Feedback type, or Bye type) of the tutor utterance is attached to each tutor utterance, and an assessment result (label success, label fail) is attached to the learner utterance.

Existing learning materials (textbooks) for tutoring use exercises to help learners acquire knowledge. The dialogue data for tutoring can be constructed or automatically generated based on exercises.

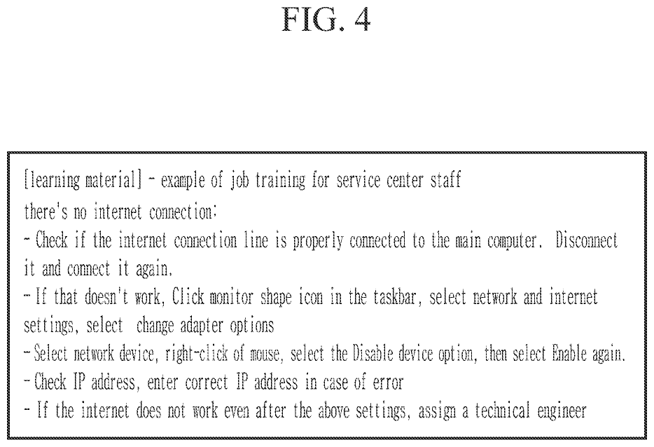

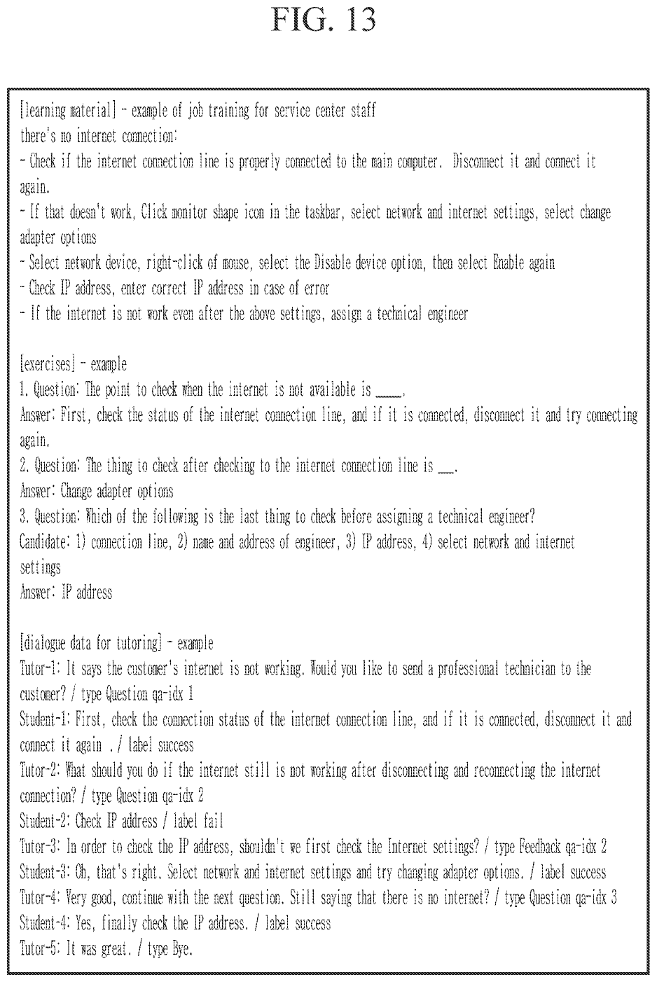

FIG. 13 is a diagram illustrating an example of dialogue data for tutoring constructed according to the example of job training for service center staff shown in FIG. 4.

Referring to FIG. 13, the job training for service center staff may include exercises. In this case, it is possible to construct or generate dialogue data for tutoring based on the learning material and exercises. At this time, question-related information, that is, the question index (qa-idx i), may be added to the tutor utterance along with the utterance type (Question type, Chat type, Feedback type, or Bye type).

FIGS. 12 and 13 are examples related to history tutoring and the job training for staff, but examples related to reading comprehension in language tutoring are not significantly different from these.

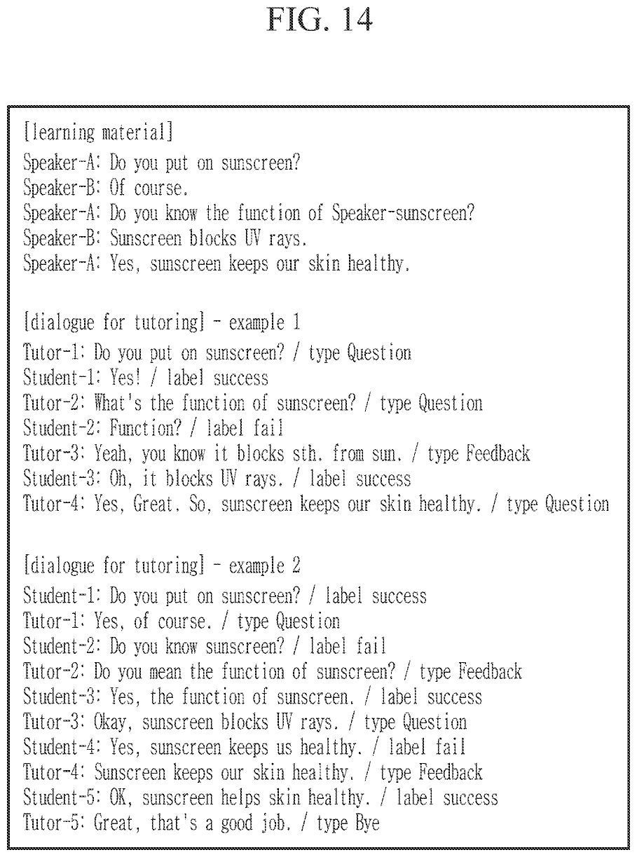

FIG. 14 is a diagram showing an example of various dialogues for tutoring constructed based on the learning materials in English tutoring shown in FIG. 5.

Referring to FIG. 14, the intelligent tutoring system 100 constructs or generates dialogues for tutoring based on learning material for English tutoring.

As in Example 1, the tutor may play the role of Speaker-A in the learning material, and as in Example 2, the student who is a learner may play the role of Speaker-A.

As can be seen in FIG. 14, the dialogues for tutoring simulate a dialogue between a tutor and a learner in order to help the learner acquire learning materials in an actual tutoring field. In FIG. 14, N in Tutor-N and Student-N means the Nth dialogue turn. Assessment result (label success, label fail) is displayed in learner utterance, and utterance type (Question type, Chat type, Feedback type, or Bye type) is displayed in tutor utterance. When the learner gives an incorrect answer, the tutor generates a tutor utterance of the Feedback type for inducing the correct answer and outputs it to the learner. When the learner gives the correct answer, the tutor generates a tutor utterance of the Question type that moves on to the next question and outputs it to the learner. When all dialogues are finished, a tutor utterance of Bye type may be generated and output it to the learner. This level is an example, and may be used in various ways in application.

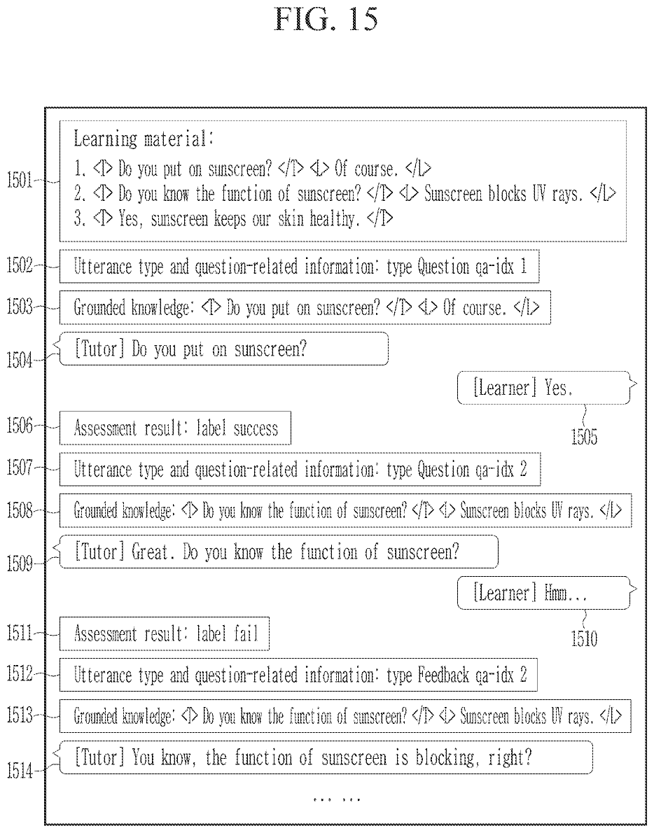

FIG. 15 is a diagram illustrating an example of an intelligent tutoring dialogue using the learning material shown in FIG. 5 of the intelligent tutoring system according to an embodiment.

Referring to FIG. 15, the intelligent tutoring system 100 automatically generates dialogues for tutoring based on the learning material 1501 shown in FIG. 5.

The dialogue example shown in FIG. 15 is one of various application examples, in which the tutor plays the role of Speaker-A and the learner plays the role of Speaker-B in the learning material.

In addition, in the learning material 1501, the format of the learning material is configured according to the dialogue model, and the part corresponding to the tutor utterance (<T> . . . </T>) and the part corresponding to the learner utterance (<L> . . . </L>) is separated by a delimiter. The format configuration of such learning materials may be performed through a pre-processing process (not shown) of the intelligent tutoring system 100.

In the first dialogue turn, the intelligent tutoring system 100 selects the utterance type and question-related information 1502 from the learning material 1501 and selects the grounded knowledge 1503 from the learning material 1501. The intelligent tutoring system 100 generates a tutor utterance 1504 based on the learning material 1501, the utterance type and question-related information 1502, and the grounded knowledge 1503 and outputs it to the learner. When the intelligent tutoring system 100 receives the learner utterance 1505 in response to the tutor utterance 1504, it assesses the learner utterance 1505 and generates an assessment result 1506 of the learner utterance. The assessment result 1506 of the learner utterance is used to select an utterance type in the next dialogue turn.

In the second dialogue turn, the intelligent tutoring system 100 selects the utterance type and question-related information 1507 based on the learning material 1501 and the assessment result 1506 of the learner utterance, selects the grounded knowledge 1508, and generates a tutor utterance 1509 based on the content 1501, the previous dialogue history 1502 to 1506, the utterance type and question-related information 1507, and the grounded knowledge 1508, and outputs the tutor utterance 1509 to the learner. When the intelligent tutoring system 100 receives the learner utterance 1510 in response to the tutor utterance 1509, it assesses the learner utterance 1510 and generates an assessment result 1511 of the learner utterance.

In the third dialogue turn, the intelligent tutoring system 100 selects the utterance type and question-related information 1512 based on the learning material 1501 and the assessment result 1511, selects the grounded knowledge 1513, and generates a tutor utterance 1514 based on the content 1501, the previous dialogue history 1502 to 1511, the utterance type and question-related information 1512, and the grounded knowledge 1513, and outputs the tutor utterance 1514 to the learner.

In this way, the intelligent tutoring system 100 performs dialogues for tutoring with the learner, while generating tutor utterances and assessing the learner utterances.

Looking at the dialogues for tutoring generated by the intelligent tutoring system 100, when the utterance type and question-related information 1502 and 1507 are “next question (Question type)”, the question index related to the learning material 1501 is changed (qa-idx 1, qa-idx 2), and accordingly, the grounded knowledge 1503 and 1508 are also changed.

In addition, when the assessment result 1511 of the learner utterance 1510 is an incorrect answer (label fail), the utterance type 1512 becomes a Feedback type, and the question index (qa-idx 2) in the question-related information 1512 maintains the existing question index (qa-idx 2), and accordingly, the grounded knowledge 1513 is not changed.

Also, in the expression of the grounded knowledge 1503, 1508, and 1513, like the expression in the learning material 1501, the intelligent tutoring system classifies the grounded knowledge to be mainly referenced in the tutor utterances 1504, 1509, and 1514 by the delimiter “<T> . . . <T>”, classifies the grounded knowledge to be mainly referenced in the assessment 1506 and 1511 of the learner utterances 1505 and 1510 by the delimiter “<L> . . . <L>”, and the intelligent tutoring system allows attention to different parts in the generation of the tutor utterances and the generation of the assessment results of the learner utterances. Also, even if the grounded knowledge 1508 and 1513 are the same, the generated tutor utterances 1509 and 1514 are different because the existing dialogue contexts including the utterance types and question-related information 1507 and 1512 are different.

The intelligent tutoring dialogue shown in FIG. 15 may also be performed by the intelligent tutoring system based on the end-to-end dialogue model 1100 shown in FIG. 11. Even if it is dialogues for tutoring by the end-to-end dialogue model 1100, if the learning for the end-to-end dialogue model 1100 is already completed, the dialogues shown in FIG. 15 are possible only with the learning material 1501.

For example, when the dialogue data for tutoring shown in FIG. 14 does not include the training data of the end-to-end dialogue model 1100, but the end-to-end dialogue 1100 is trained with another sufficient amount of dialogue data for English tutoring, it is possible to perform the dialogue for tutoring as shown in FIG. 15 if only the learning material shown in FIG. 5 are provided without the dialogue data for tutoring as shown in FIG. 14.

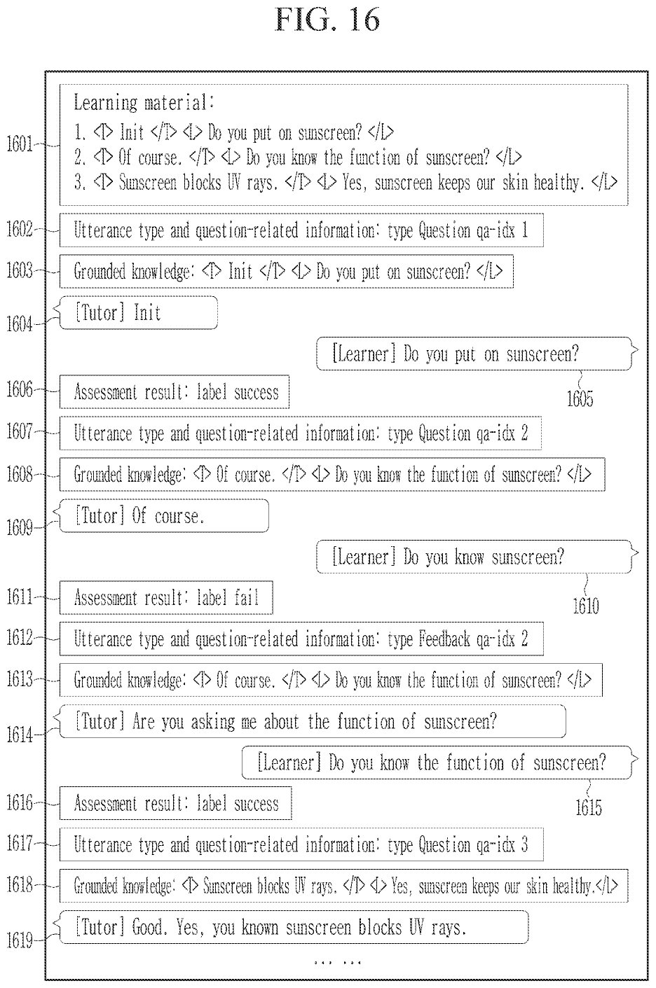

FIG. 16 is a diagram illustrating another example of an intelligent tutoring dialogue using the learning material shown in FIG. 5 of the intelligent tutoring system according to an embodiment, and unlike FIG. 15, shows a case in which the learner speaks first.

Referring to FIG. 16, the intelligent tutoring system 100 allows the learner to speak first, and automatically generates dialogue for tutoring by selecting the utterance type and question-related information 1602, 1607, 1612, and 1617 in each dialogue turn based on the learning material 1601 and the assessment results 1606, 1611, and 1616 of the learner utterances, selecting the grounded knowledge 1703, 1608, 1613, and 1618, generating the tutor utterances 1609, 1614, and 1619 with reference to all information in the previous dialogue context, assessing the learner utterances 1605, 1610, and 1615, and outputting the assessment results 1606, 1611, and 1616 of the learner utterances 1605, 1610, and 1615, in a similar way to the previously described method.

Comparing the dialogue for tutoring shown in FIG. 16 with FIG. 15, since the learner must first utter, the speaker configuration is changed in the learning material 1601, and the tutor utterance 1604 in the first dialogue turn is processed as initialization Init. In an actual service, the intelligent tutoring system 100 may appear to wait for the user input without outputting anything in the first dialogue turn.

The intelligent tutoring dialogue shown in FIG. 16 may also be performed by the intelligent tutoring system based on the end-to-end dialogue model 1100 shown in FIG. 11.

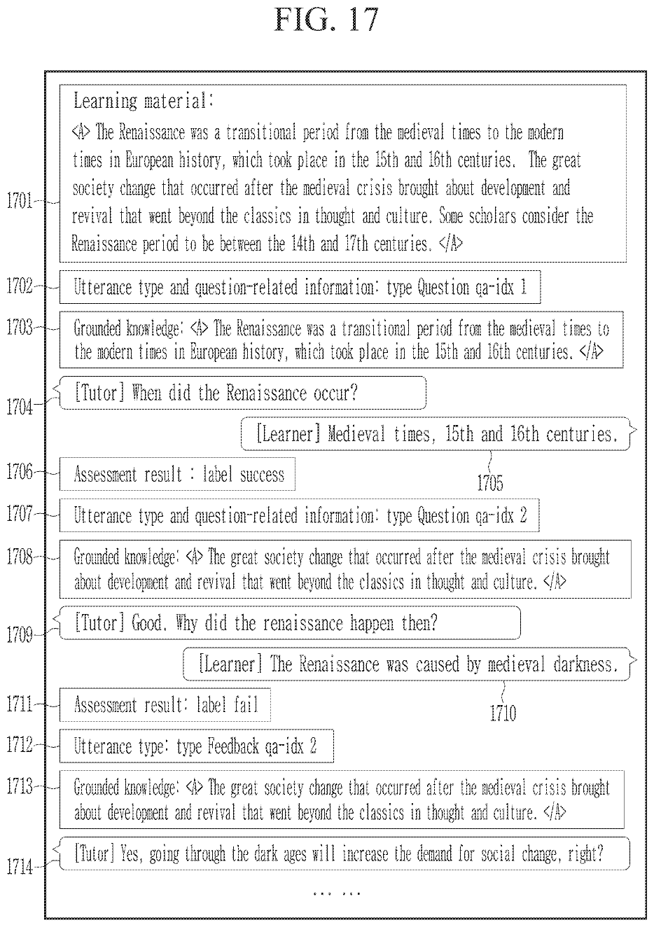

FIG. 17 is a diagram illustrating an example of an intelligent tutoring dialogue using the learning material shown in FIG. 3 of the intelligent tutoring system according to an embodiment.

Referring to FIG. 17, the intelligent tutoring system 100 automatically generates dialogue for tutoring by selecting the utterance type and question-related information 1702, 1707, and 1712 in each dialogue turn based on the learning material 1701 and the assessment results 1706 and 1711 of the learner utterance for history tutoring shown in FIG. 3, selecting the grounded knowledge 1703, 1708, and 1713, generating the tutor utterances 1704, 1709, and 1714 with reference to all information in the previous dialogue context, assessing the learner utterances 1705 and 1710, and outputting the assessment results 1706 and 1711 of the learner utterances 1705 and 1710.

Comparing the tutoring dialogue shown in FIG. 17 with FIGS. 14 and 15, there is no speaker-related reference knowledge in the learning material 1701, and there is no speaker classification or question/correct answer classification in the grounded knowledge 1703 and 1708. That is, the intelligent tutoring system 100 generates questions from the tutor utterances 1704 and 1709 with reference to the grounded knowledge, and assesses the learner utterances 1705 and 1710 to output the assessment results 1706 and 1711. In this case, the expression of the grounded knowledge is an example, and in actual use, information such as a question point or a 5W1H question type may also be expressed in the grounded knowledge 1703 and 1708 as described with reference to FIG. 7.

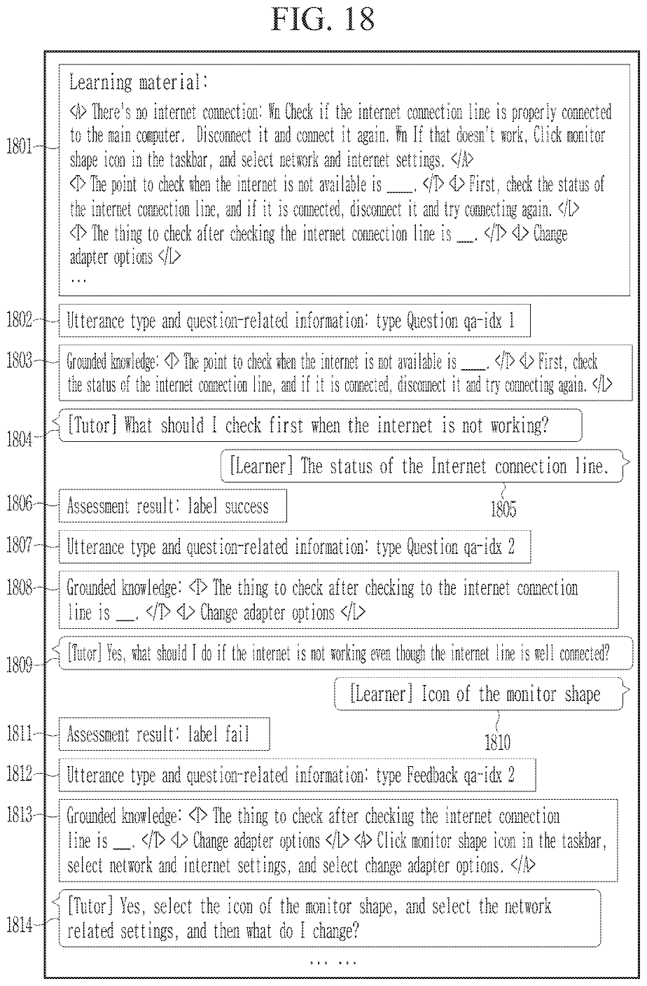

FIG. 18 is a diagram illustrating an example of an intelligent tutoring dialogue using the learning material shown in FIG. 4 of an intelligent tutoring system according to an embodiment, and shows an example of a dialogue generated using the exercises included in the learning material as shown in FIG. 13.

Referring to FIG. 18, the intelligent tutoring system 100 automatically generates dialogue for tutoring by selecting the utterance type and question-related information 1802, 1807, and 1812 in each dialogue turn based on the learning material 1801 including the exercises shown in FIG. 13 and the assessment results 1806 and 1811 of the learner utterance, selecting the grounded knowledge 1803, 1808, and 1813, generating the tutor utterances 1804, 1809, and 1814 with reference to all information in the previous dialogue context, assessing the learner utterances 1805 and 1810, and outputting the assessment results 1806 and 1811 of the learner utterances 1805 and 1810.

Referring to the tutoring dialogue shown in FIG. 18, even if the exercises are not complete sentences, and are in the form of filling in blanks, the intelligent tutoring system 100 can generate a complete question by using it regardless of this. In addition, in order to improve accuracy, the Question type tutor utterances 1804 and 1809 mainly use exercises as the grounded knowledge 1803 and 1808, but when the learner utterance 1810 is an error 1811, in order to generate utterances of the Feedback type, a related sentence among the knowledge descriptions in the learning material is also selected along with the exercises as the grounded knowledge 1813. In this case, the exercises <T> . . . </T> and <L>< . . . /L> and the knowledge description part <A> . . . </A> are separated by different tags so that the model can focus their attention.

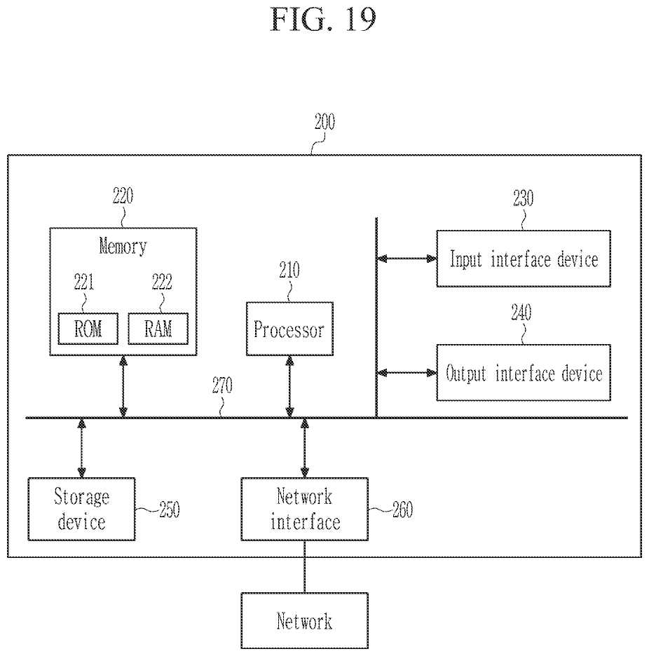

FIG. 19 is a diagram illustrating an intelligent tutoring system according to another embodiment.

Referring to FIG. 19, the intelligent tutoring system 200 may represent a computing system in which the aforementioned intelligent tutoring method is implemented.

The intelligent tutoring system 200 may include at least one of processor 210, a memory 220, an input interface device 230, an output interface device 240, a storage device 250, and a network interface device 260. Each of the components may be connected by a common bus 270 to communicate with each other. In addition, each of the components may be connected through an individual interface or a separate bus centering on the processor 210 instead of the common bus 270.

The processor 210 may be implemented as various types such as an application processor (AP), a central processing unit (CPU), a graphics processing unit (GPU), etc., and may be any semiconductor device that executes a command stored in the memory 220 or the storage device 250. The processor 210 may execute program commands stored in at least one of the memory 220 and the storage device 250. The processor 210 is a program for implementing at least some functions of the utterance type selector 110, the grounded knowledge selector 120, the tutor utterance generator 130, and the learner utterance assessor 140 described with reference to FIG. 1 in the memory 220, and may control to perform the operation described with reference to FIGS. 1 to 18.

The memory 220 and the storage device 250 may include various types of volatile or non-volatile storage media. For example, the memory 220 may include a read-only memory (ROM) 221 and a random access memory (RAM) 222. The memory 220 may be located inside or outside the processor 210, and the memory 220 may be connected to the processor 210 through various known means.

The input interface device 230 is configured to provide input data to the processor 210. For example, the input interface device 230 may be configured to provide learning material or learner utterances to the processor 210. The input interface device may include, for example, a microphone. The learner utterances may be input through a microphone.

The output interface device 240 is configured to output data from the processor 210. For example, the output interface device 240 may be configured to provide the tutor utterances and learning material to the learner. The output interface device 240 may include, for example, a speaker or a screen. The tutor utterances may be output through a speaker, and the learning material may be output through a screen.

The network interface apparatus 260 may transmit or receive data and signals with other devices through a wired network or a wireless network. At least some of the intelligent tutoring method according to an embodiment of the present disclosure may be implemented as a program or software executed in a computing device, and the program or software may be stored in a computer-readable medium.

In addition, at least some of the intelligent tutoring method according to an embodiment of the present disclosure may be implemented as hardware that can be electrically connected to the computing device.

According to an embodiment, it is possible to simulate a 1:1 tutoring environment such as a visiting tutor tutoring by converting the learning materials into a conversational dialogue format. In particular, if there are only existing contents for tutoring, it is possible to easily construct a dialogue scenario based on it, and accordingly, it can be easily utilized in the existing tutoring world. It can be used in various tutoring fields that have learning material and can be tutored in a dialogue format, for example, language tutoring, history tutoring, and staff job training.

In addition, by learning and executing assessment of learner utterance and tutor utterance using a single end-to-end dialogue model, training and management of the model is easy.

In addition, when “dialogue” is extended to an interaction that exchanges information between a learner and a system acting as a tutor, various forms of intelligent tutoring systems such as the user and the system communicate only with pictures, the system communicates with pictures and the learner communicates with voice, etc. can be used.

The components described in the example embodiments may be implemented by hardware components including, for example, at least one digital signal processor (DSP), a processor, a controller, an application-specific integrated circuit (ASIC), a programmable logic element such as an FPGA, other electronic devices, or combinations thereof. At least some of the functions or the processes described in the example embodiments may be implemented by software, and the software may be recorded on a recording medium. The components, functions, and processes described in the example embodiments may be implemented by a combination of hardware and software. The method according to embodiments may be embodied as a program that is executable by a computer, and may be implemented as various recording media such as a magnetic storage medium, an optical reading medium, and a digital storage medium. Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing, or to control an operation of a data processing apparatus, e.g., by a programmable processor, a computer, or multiple computers. A computer program(s) may be written in any form of programming language, including compiled or interpreted languages, and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network. Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic or magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read-only memory (CD-ROM), a digital video disk (DVD), etc., and magneto-optical media such as a floptical disk and a read-only memory (ROM), a random access memory (RAM), a flash memory, an erasable programmable ROM (EPROM), and an electrically erasable programmable ROM (EEPROM), and any other known computer readable media. A processor and a memory may be supplemented by, or integrated into, a special purpose logic circuit. The processor may run an operating system (OS) and one or more software applications that run on the OS. The processor device may also access, store, manipulate, process, and create data in response to execution of the software. For the purpose of simplicity, the description of a processor device is used as singular; however, one skilled in the art will appreciate that a processor device may include multiple processing elements and/or multiple types of processing elements. For example, a processor device may include multiple processors or a processor and a controller. In addition, different processing configurations are possible, such as parallel processors. Also, non-transitory computer-readable media may be any available media that may be accessed by a computer, and may include both computer storage media and transmission media. The present specification includes details of a number of specific implementations, but it should be understood that the details do not limit any disclosure or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination. Similarly, even though operations are described in a specific order in the drawings, it should not be understood as the operations needing to be performed in the specific order or in sequence to obtain desired results or as all the operations needing to be performed. In a specific case, multitasking and parallel processing may be advantageous. In addition, it should not be understood as requiring separation of various apparatus components in the above-described example embodiments in all example embodiments, and it should be understood that the above-described program components and apparatuses may be incorporated into a single software product or may be packaged in multiple software products.

It should be understood that the embodiments disclosed herein are merely illustrative and are not intended to limit the scope of the disclosure. It will be apparent to one of ordinary skill in the art that various modifications of the embodiments may be made without departing from the spirit and scope of the claims and their equivalents.

What is claimed is:

1. An intelligent tutoring method of an intelligent tutoring system, the method comprising:
receiving learning material;
selecting an utterance type in a current dialogue turn;
selecting grounded knowledge from the learning material according to the selected utterance type in the current dialogue turn;
generating a tutor utterance based on the selected utterance type, the grounded knowledge, and the learning material in the current dialogue turn and outputting it to the learner,
receiving a learner utterance in response to the tutor utterance in the current dialogue turn; and
generating an assessment result of the learner utterance by assessing the learner utterance in the current c dialogue turn.

2. The method of claim 1, wherein the selecting the grounded knowledge includes:
selecting key sentences from the learning material with reference to the selected utterance type; and
selecting the key sentences as the grounded knowledge.

3. The method of claim 2, wherein the selecting the key sentences includes selecting the key sentences from the learning material based on the selected utterance type and the assessment result of the learner utterance in a previous dialogue turn.

4. The method of claim 2, wherein the selecting the key sentences as the grounded knowledge includes classifying whether the grounded knowledge is the grounded knowledge to be referenced for the tutor utterance or the grounded knowledge to be referenced for the assessment of the learner utterance.

5. The method of claim 2, wherein the selecting the grounded knowledge further includes selecting a question point in the key sentences.

6. The method of claim 1, wherein the utterance type includes at least a Question type and a Feedback type, and
the selecting the utterance type includes:
selecting the utterance type of the current dialogue turn as the Feedback type when the assessment result of the learner utterance in the previous dialogue turn indicates an incorrect answer, and
using a question index of the previous dialogue turn as the question index of the current dialogue turn.

7. The method of claim 6, wherein the selecting the ground knowledge includes selecting the ground knowledge selected in the previous dialogue turn as the ground knowledge in the current dialogue turn when the utterance type in the current dialogue turn is the Feedback type.

8. An intelligent tutoring method of an intelligent tutoring system, the method comprising:
receiving learning material, utterance types up to a current dialogue turn, and ground knowledge selected from the learning material as inputs, and generating a tutor utterance in the current dialogue turn and outputting it to the learner, in one learned end-to-end dialogue model; and
receiving, as inputs, the tutor utterance in the current dialogue turn and the learner utterance corresponding to the tutor utterance, and assessing the learner utterance, in the one end-to-end dialogue model.

9. The method of claim 8, further comprising:
receiving the learning material;
selecting an utterance type in the current dialogue turn;
selecting the ground knowledge from the learning material according to the utterance type selected in the current dialogue turn; and
inputting the learning material, the utterance type in the current dialogue turn, and the ground knowledge into the one end-to-end dialogue model.

10. The method of claim 9, wherein the selecting the utterance type in the current dialogue turn includes selecting the utterance type in the current dialogue turn based on the assessment result of the learner utterance assessed by the one end-to-end dialogue model in the previous dialogue turn and the learning material.

11. The method of claim 9, wherein the selecting the utterance type includes, in the one end-to-end dialogue model, receiving the learning material and the assessment result of the learner utterance assessed by the one end-to-end dialogue model in the previous dialogue turn as inputs, and determining the utterance type in the current dialogue turn.

12. The method of claim 8, wherein the generating the tutor utterance in the current dialogue turn and outputting it to the learner includes inputting the assessment result of the learner utterance assessed by the one end-to-end dialogue model into the one end-to-end dialogue model for generating a tutor utterance in the next dialogue turn.

13. The method of claim 8, wherein the generating the tutor utterance in the current dialogue turn and outputting it to the learner includes selecting the ground knowledge by using the learning material and the utterance types up to the current dialogue turn in the one end-to-end dialogue model.

14. The method of claim 8, further comprising training the end-to-end dialogue model using training data,
wherein the training includes generating the training data from the learning material.

15. An intelligent tutoring system, the system comprising:
an utterance type selector that selects an utterance type based on input learning material;
a grounded knowledge selector that selects grounded knowledge from the learning material based on the selected utterance type:
a tutor utterance generator that generates based on the learning material, the selected utterance type and grounded knowledge, and outputs tutor utterance to a learner; and
a learner utterance assessor that receives a learner utterance corresponding to the tutor utterance, and generates an assessment result of the learner utterance by assessing the learner utterance based on at least one of the learning material, the utterance type, the grounded content, and the tutor utterance.

16. The system of claim 15, wherein the grounded knowledge selector classifies the grounded knowledge selected from the learning material into the grounded knowledge required for the tutor utterance and the grounded knowledge required for the assessment of the learner utterance.

17. The system of claim 15, wherein the grounded knowledge selector selects key sentences from the learning material according to the utterance type, and outputs the key sentences as the grounded knowledge.

18. The system of claim 15, wherein the tutor utterance generator generates the tutor utterance based on the learning material, the assessment result of the learner utterance and the learner utterance in the previous dialogue turn, and the utterance type and grounded knowledge in the current dialogue turn.

19. The system of claim 15, wherein the tutor utterance generator and the learner utterance assessor generate the tutor utterance using one learned end-to-end dialogue model and assess the learner utterance.

20. The system of claim 19, wherein the utterance type selector selects the utterance type using the one end-to-end dialogue model, or
the grounded knowledge selector selects the grounded knowledge by using the one end-to-end dialogue model.
